(19) United States
(12) Patent Application Publication
(10) Pub. No.: US 2025/0345956 A1
(43) Pub. Date: Nov. 13, 2025

(54) TOOL WITH ERGONOMIC HANDLE AND REPLACEABLE CUTTER HEAD

(71) Applicant: Klever Innovations LLC, Norton Shores, MI (US)

(72) Inventors: Matthew Jacobs, Grand Haven, MI (US); Jeffrey Kempker, Muskegon, MI (US); Orville Crain, Muskegon, MI (US)

(21) Appl. No.: 19/096,692

(22) Filed: Mar. 31, 2025

Related U.S. Application Data
(63) Continuation of application No. 17/334,866, filed on May 31, 2021, now Pat. No. 12,263,610.
Application No. 17/334,866 is a continuation-in-part of application No. 16/571,126, filed on Sep. 15, 2019, now Pat. No. 11,052,552.
Application No. 16/571,126 is a continuation-in-part of application No. 13/866,074, filed on Apr. 19, 2013, now Pat. No. 10,442,093.
Application No. 13/866,074 is a continuation-in-part of application No. 12/620,999, filed on Nov. 18, 2009, now abandoned.
Application No. 17/334,866 is a continuation-in-part of application No. PCT/US2020/036514, filed on Jun. 6, 2020.
(60) Provisional application No. 61/138,262, filed on Dec. 17, 2008.
(60) Provisional application No. 63/030,593, filed on May 27, 2020.

(51) Int. Cl. B26B 5/00; B25F 1/02; B25G 1/10; B25G 3/18; B26B 25/00; B26B 27/00

(52) U.S. Cl. CPC B26B 5/00; B25F 1/02; B25G 1/102; B25G 3/18; B26B 25/005; B26B 27/005; Y10T 83/04

(57) ABSTRACT

A tool includes an elongated handle with an end recess and a side notch for latching, and a plurality of different replaceable heads. Each replaceable head includes an elongated rectangular section shaped to fit stably into the recess for providing torsional and lateral support, an operative end, and a latch releasably engaging the side notch to retain the head in the recess. The different heads can include different operative ends with structure for providing different operative functions, such as a head with oppositely-positioned partially-shielded blade tips and/or with different blade throat sizes, a head with pizza-cutting wheel, a head with hammer or wrench feature, and the like.

### CROSS-REFERENCE TO RELATED APPLICATION

This application is a continuation of U.S. patent application Ser. No. 17/334,866, filed May 31, 2021, now U.S. Pat. No. 12,263,610 issued on Apr. 1, 2025, the entire disclosure of which is incorporated herein by reference in its entirety. U.S. patent application Ser. No. 17/334,866 is a continuation-in-part of U.S. patent application Ser. No. 16/571,126, filed Sep. 15, 2019, now U.S. Pat. No. 11,052,552 issued on Jul. 6, 2021, which is a continuation-in-part of U.S. patent application Ser. No. 13/866,074, filed Apr. 19, 2013, now U.S. Pat. No. 10,442,093 issued on Oct. 15, 2019, which is a continuation of U.S. patent application Ser. No. 12/620,999, filed on Nov. 18, 2009, which claims the benefit of U.S. Provisional Patent Application Ser. No. 61/138,262, filed Dec. 17, 2008, the entire disclosures of which are incorporated herein by reference in their entirety. U.S. patent application Ser. No. 17/334,866 is also a continuation-in-part of PCT Patent Application Number PCT/US2020/036514, filed Jun. 6, 2020, which claims the benefit of U.S. Provisional Patent Application Ser. No. 63/030,593, filed May 27, 2020, the entire disclosures of which are incorporated herein by reference in their entirety.

### BACKGROUND

The present invention relates to hand-held tools having ergonomic handles and replaceable heads, and in particular to a tool having multiple different heads each with insert-molded blades and/or cutting features and/or functional heads adapted for different uses.

Many different box cutters exist. One known cutter (See Kempker U.S. Pat. Nos. D521,844 and D527,604) has two partially-shielded oppositely-positioned blades at its operative end. This provides double the use prior to the blade(s) being worn out. However, once the blades are worn out, the entire cutter must be discarded.

Some cutters deal with worn out blades by providing replaceable blades. However, most known cutters with replaceable blades are single bladed and have a single cutting surface, which results in a need to replace the (single) blade more often than desired. Further, the procedure for replacing blades (especially those adapted for heavy duty or high volume cutting applications) is often cumbersome, complex, time-consuming, and/or not intuitive. Further, in most known cutters, the blades are not shielded during use, thus exposing the user to safety concerns and/or exposing the product to damage when packaging is being cut away. Another concern is stability of the blade and concurrently, sureness of the retainer device for holding the blade. Stability and retention is potentially easier to manage in a single blade than with two-bladed cutters, since the stresses on a single blade act in “single” predictable way when pressure is put on the single blade. Further, the stresses are not applied in a back-and-forth manner that can lead to the blade working loose. Contrastingly, stability in a double blade cutter is more difficult since the stresses are alternatively in a first direction and then in a different second direction (depending on which of the two blades is being used) . . . which can lead to working the blades back and forth until the blade may become loose. Also, the back-and-forth stresses can provide problems for the retainer mechanism, such as by working loose the retainer mechanism and/or causing wear resulting in the retainer mechanism unexpectedly releasing. Retainer mechanisms can potentially be made “beefier” and more secure, however this tends to make the retainer mechanisms more expensive, more difficult to release, and more complex than desired.

Another concern is adaptability and flexibility of cutters. Different blades and cutters are adapted for different uses. However, known cutters cannot be easily adapted for different tasks. For example, one task may require cutting a relatively thick cardboard box (where a particular blade angle and relatively-open blade throat is required) and a following task may require cutting relatively thinner paper (where a different blade angle and narrower blade throat is required) and a third task may require cutting a stiff sheet of corrugated material (requiring a still different angle and blade throat). Single blades are often not able to work well on each of these different tasks. Also, cutters are not easily adapted for specialized uses, such as where a pointed tip is desired for poking a hole through a sheet (without damaging a product thereunder) prior to initiating the cut.

Another concern is the handle. Many cutters do not have an ergonomically designed handle, and as a result they are uncomfortable and cause stress to a user's hand when used for significant periods of time.

### SUMMARY OF THE PRESENT INVENTION

In one aspect of the present invention, a hand tool includes an elongated handle with a recess in one end and a side notch extending laterally in the recess, and at least one replaceable head with an operative end, an elongated section shaped to fit stably and securely into the recess for torsional support with the operative end extending from the elongated section, and a latch releasably engaging the side notch to retain the elongated section in the recess.

In a narrower aspect, the replaceable head includes two blade surfaces, each being on different sides of the handle.

In a narrower aspect, a plurality of different heads are provided, each having a different operative end for providing a different functional use.

In another aspect of the present invention, an apparatus includes a handle with a recess and a side notch in the recess, and a plurality of replaceable heads. Each of the heads has an elongated section shaped to fit stably into the recess, an operative end extending from the elongated section, and a latch adapted to releasably engage the side notch to retain the head in the recess. Each of the operative ends of the replaceable heads include a different structure for providing a different cutting function, such as a shielded blade with different blade throat, or different angled blade, or with a different shielded blade arrangement.

In another aspect of the present invention, a hand tool includes an elongated handle with a recess in one end and a side notch extending laterally in the recess, and a replaceable head with an operative end. An elongated section is shaped to fit stably and securely into the recess for torsional support with the operative end extending from the elongated section, and a latch releasably engaging the side notch to retain the elongated section in the recess against a pull out force encountered when the operative end is in use; the operative end including two exposed blade surfaces, one on each side of the handle.

In another aspect of the present invention, a handle for a hand tool includes an elongated handle with a rectangular recess in one end and a side notch extending laterally in the recess. The recess is adapted and configured to receive and stably support an elongated section of a replaceable head for torsional support, and the side notch is adapted and configured to receive a latch extending from the elongated section to retain the elongated section in the recess against a pull out force encountered when the replaceable head is in use.

In another aspect of the present invention, a method of cutting comprises steps of providing a hand tool with a handle and a first releasable replaceable head attached to the handle, the head having two blade surfaces on opposing sides of the handle and further having shields that both protect outer tips of both blade surfaces and also define throats leading to the blade surfaces; cutting material with the blade surfaces by passing material into the throats until the two blade surfaces are worn; pressing a latch to release the first releasable replaceable head; and attaching a second releasable replaceable head to the handle.

These and other aspects, objects, and features of the present invention will be understood and appreciated by those skilled in the art upon studying the following specification, claims, and appended drawings.

### BRIEF DESCRIPTION OF DRAWINGS

FIGS. 1-2 are perspective views of a first tool with handle and replaceable cutter head in an assembled configuration, FIG. 2 being transparent in part.

FIG. 3 is an exploded view of FIG. 1, the replaceable cutter head separated from the handle.

FIGS. 4-6 are perspective views of alternative tools with different cutter heads, FIG. 4 being transparent in part.

FIGS. 7-8 are perspective views of another tool with handle and replaceable cutter head, FIG. 7 being in an assembled configuration, FIG. 7A shown without a replaceable cutter head, and FIG. 8 being exploded with the replaceable cutter head separated from the handle.

FIGS. 9-10 are plan and edge views of the handle of FIG. 7A.

FIGS. 11-11A are cross-sectional views taken along lines XI-XI in FIG. 9; FIG. 11A being an enlarged view of the indicated area of detail shown in FIG. 11.

FIG. 12 is a cross-sectional view taken along lines XII-XII in FIG. 10.

FIGS. 13-13A are cross-sectional views taken along lines XI-XI in FIG. 9; FIG. 13 showing a replaceable cutter head partially inserted into the handle and FIG. 13A showing a replaceable cutter head fully inserted into the handle.

FIG. 14 is a perspective view of the replaceable cutter head in FIG. 8.

FIGS. 15-19 are side, plan, opposite side, end and opposite end views of the replaceable cutter head in FIG. 14.

FIG. 20 is a perspective view, similar to FIG. 14, showing an insert-molded blade in a replaceable cutter head.

FIG. 21 are perspective views of alternative replaceable cutter heads for a handle.

### DETAILED DESCRIPTION OF PREFERRED EMBODIMENTS

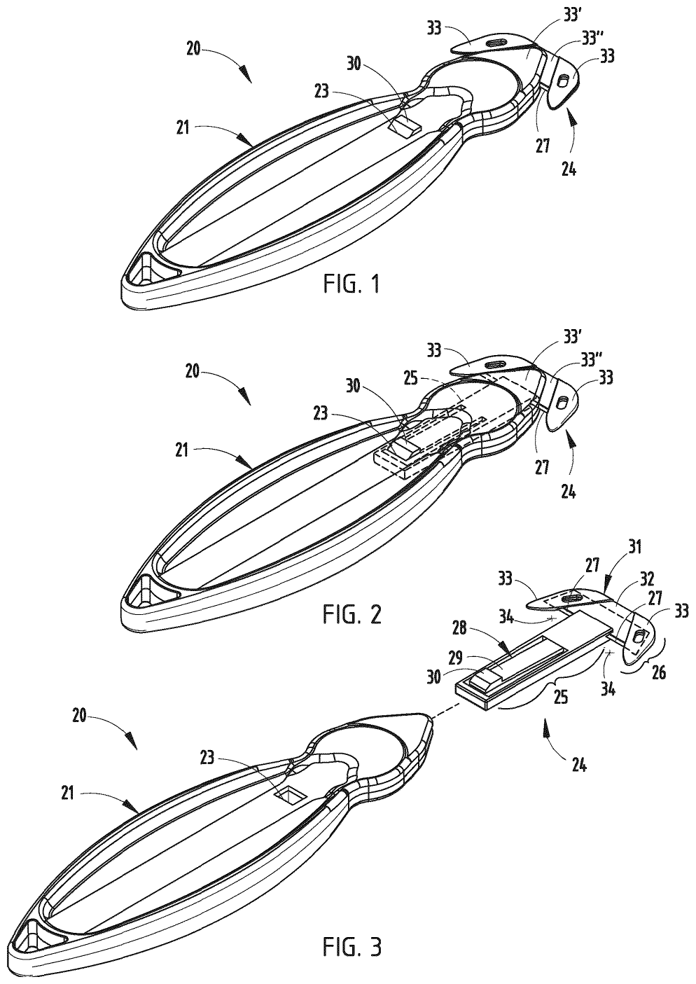

A tool 20 (FIGS. 1-3) includes an elongated handle 21 with a recess 22 in one end and a side notch (or hole) 23, and a plurality of different replaceable heads such as cutter head 24 (and see also the heads in FIGS. 4-6 and 21). Each replaceable head 24 includes an elongated section 25 shaped to fit stably and securely into the recess 22 for torsional support, an integrally-formed operative end 26 extending from the elongated section 25 with oppositely-positioned partially-shielded blades 27, and an integrally-formed latch 28 on resilient finger or stem 29 with protrusion 30 releasably engaging the side notch 23 to retain the head 24 in the recess 22. The finger 29 extends generally parallel the elongated section 25, and may be planar or have a slightly increasing thickness to better distribute stress away from its base/root. The section 25 is generally a three-dimensional rectangular shape and shaped to closely engage the mating recess 22 to provide a very stable interconnection regardless of stresses on either of the two oppositely positioned blades 27. The protrusion 30 faces in a direction perpendicular to a direction defined by the blades 27, such that stresses on the blades 27 during use tend to be in a plane different than the direction of release for the latch 28, such that using the blades does not result in forces that would cause the head 24 to unexpectedly release. Further, the recess 22 closely engages the section 25 such that it provides support against torsional and lateral stress, which also reduces a tendency for unexpected pull-out.

The illustrated head 24 includes a single piece of steel with a continuous cutting edge that forms both blades 27. Specifically, it includes a body 31 of polymeric material insert-molded onto the steel, such that two spaced portions of the continuous cutting edge are exposed (i.e., thus forming the two blades 27 referred to above). The body 31 includes material 32 on its operative end that holds the blades 27 to the elongated section 25. The body 31 further includes two overhanging hook-shaped shields 33 that protect and cover outer edges/tips of the single piece of steel while exposing two knife edges (blades 27) on either side of the body. The body 31 also includes material 33′ that forms an inner side of the throat leading to the blades 27, and a thinned area of material 33″ that connects the shields 33 with the material 33′. Notably, the section 25 extends from the material 33′. The end of the handle 21 combines with the shields 33 to define a shielded blade throat 34. The blade throat 34 is small enough to provide limited access to the exposed cutting edge of the blades 27, thus providing an improved degree of safety when using the blade to cut sheet material. Notably, the blade throat 34 and angle of the exposed cutting edge of the blade(s) 27 can be very important for optimal and efficient use of the cutter.

In particular, it is contemplated that different heads can be provided with different operative ends each with different structure for providing a different cutting function, such as a shielded blade with different blade throat size, or differently angled blade, or with a different shielded (or unshielded) blade arrangement. For example, a head can be constructed with a throat size and blade angle for optimally cutting different materials such as non-corrugated cardboard, corrugated cardboard, paper, carpet, plastic, composite sheet, thin-metal sheet, animal skin, leather, rolled-out cookie-dough, etc.

A modified cutter 20 (FIG. 4) includes a head 24A having only a point-location single blade 27A on one side, and with a more limited tip shield 33A. Specifically, the exposed cutting edge of the blade 27A has a slightly rounded cutting tip (and less of an elongated knife-like cutting surface as compared to blade 27). The tip shield 33A is reconfigured to pierce into a sheet of cardboard or paper to being a cut, while preventing personal injury from the blade 27A. Like head 24, the head 24A includes a rectangular elongated section 25 shaped to fit stably into the recess 22, an integrally-formed operative end 26 extending from the elongated section 25 (but with a single less-partially-shielded blade 27A), and a latch 28 on resilient finger 29 with protrusion 30 releasably engaging the side notch 23.

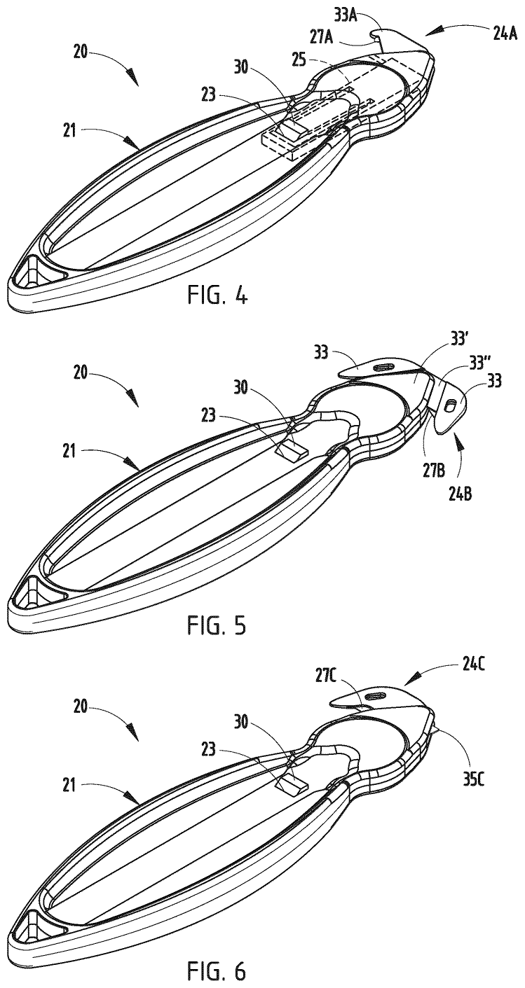

FIG. 5 illustrates another modified cutter with head 24B having (separate) angled blades 27B providing cutting surfaces that are not co-linear but instead are oppositely and outwardly angled. Also, the blade throat in head 24B is slightly modified in size and shape to better funnel the particular sheet-like product being cut into a “preferred” part of the blade's cutting edge.

FIG. 6 discloses another modified cutter 20 with head 24C having a single blade 27C on one side and an exposed pointed protrusion 35C on the side opposite the blade 27C. For example, the protrusion 35C can be made for creating a score line or scribe line on a sheet material. It is contemplated that the protrusion 35C can be made of plastic material (as opposed to steel or metal) and/or metal, and can be made rounded and/or slightly dulled to reduce its tendency to cut since it is exposed. It is contemplated that the protrusion 35C can be made similar to the arrangement shown in FIG. 4 on cutter 20A. Also, it is contemplated that other blades and cutters can be on a head, such as a thin-metal roller can be positioned in the head with an edge of the roller being exposed at an end of the tool or at a side location similar to protrusion 35C.

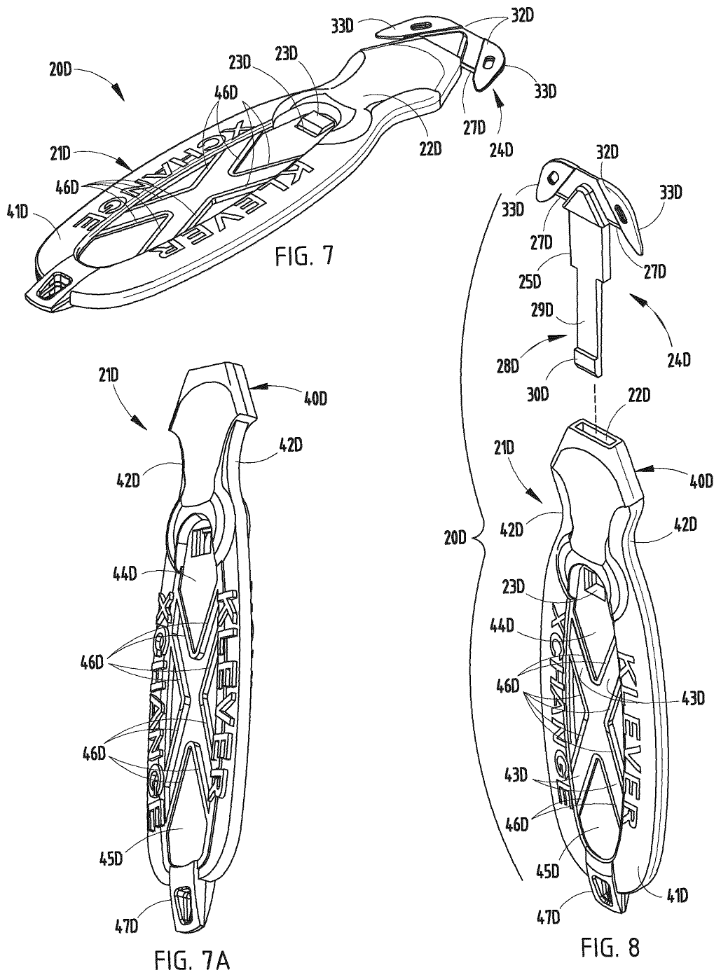

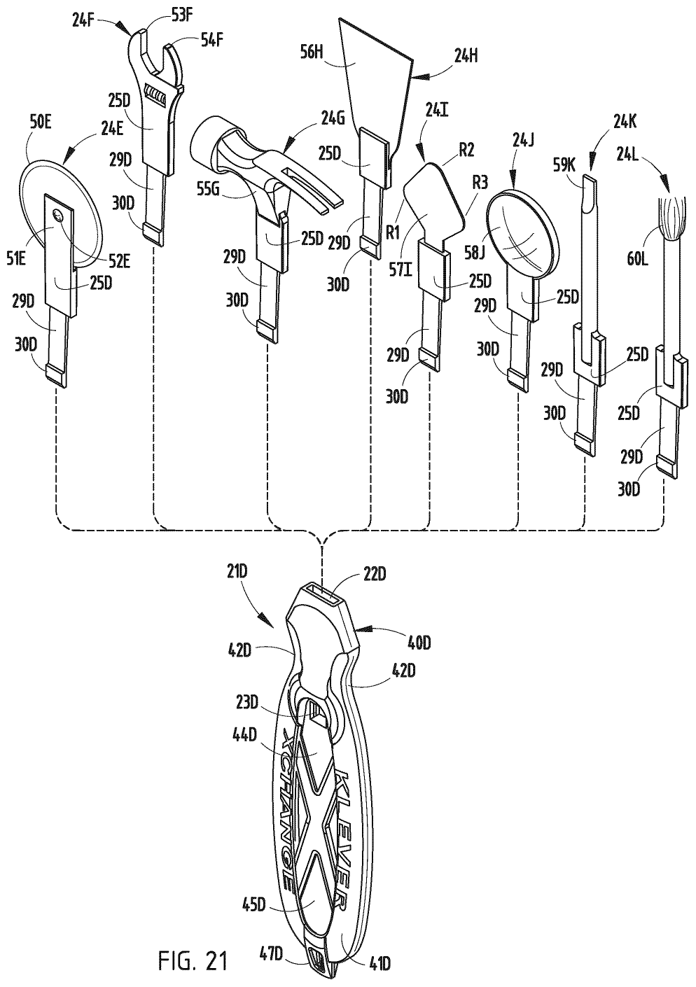

A modified tool 20D (FIGS. 7-8) includes a handle 21D with a recess 22D and a side notch (or hole) 23D, and a plurality of different replaceable cutter heads 24D-I FIGS. 8 and 21). The handle 21D is designed for ergonomics of hand-held use, and includes a structural backbone molded component 40D (FIG. 7A) (such as a structural plastic like 33% glass-filled polypropylene or other reinforced polyolefin or plastic such as ABS or polycarbonate, depending on the application) and an over-molded resilient material 41D (FIGS. 7 and 8) (such as a resilient rubber-like material like synthetic rubber, urethane, or thermoplastic elastomer (TPE) with durometer of about 60 Shore A) that provides several functions including a soft hand feel, a frictional surface for easier gripping, especially in the thumb and palm areas 42D and 43D, respectively, and an attractive appearance. As illustrated, the over-molded areas are interconnected so that the rubber-like resilient material can be shot in a single injection molding cycle. The thumb and palm areas 42D and 43D are slightly thicker in order to provide optimal feel and frictional gripping strength for a person' hand and fingers. Two recessed areas 44D and 45D (FIG. 9) include perimeter ribs that add stiffness to the handle and also that act as dams to keep rubber material out of the area 44D and 45D (such as to save material cost of the rubber material) and also to prevent the rubber material from filling the side notch 23D. The X-shaped criss-cross ribs 46D also increase handle strength. A tail section 47D provides additional useful function on the tool, including a hole 48D allowing the tool to be hung on a wall-mounted peg and also the tail section 47D can be dragged across a surface to form/draw a line on a sheet of material. A size of the handle can be varied for particular audience/user group. The illustrated handle 21D is about 1¼″ to 1½″ wide, and about ¼″ to ½″ thick, and about 5″ to 6″ long, and includes undulations forming thumb-receiving recesses along its perimeter. A thickness of the rubber in areas 42D can be 1/16″ to ⅛″ thick, depending on user preference and tool function (i.e. likely amount of stress when using the tool).

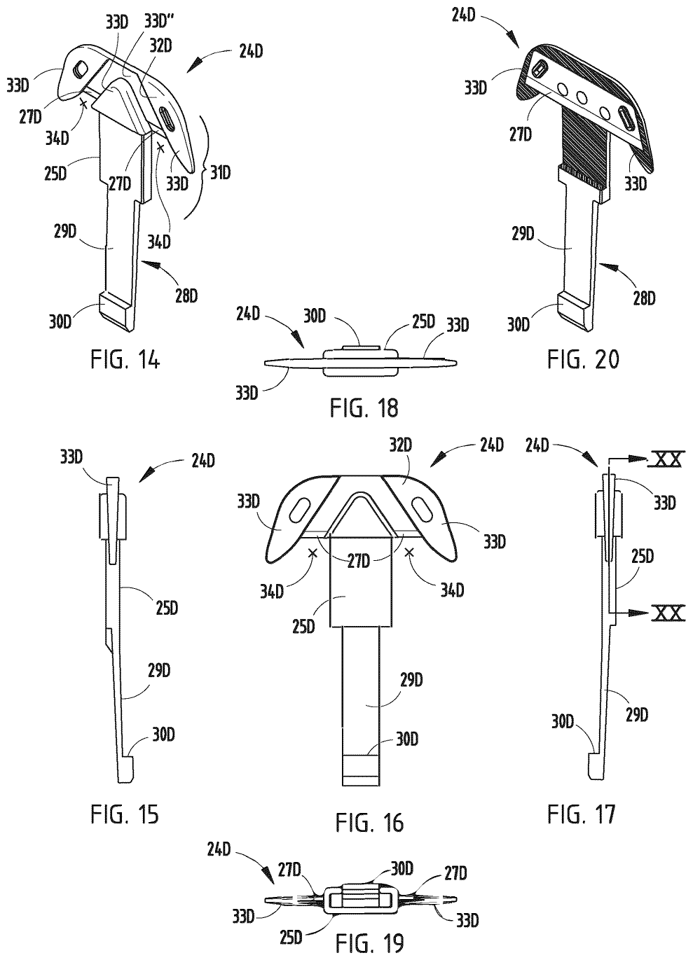

The replaceable head 24D includes an elongated section 25D (FIGS. 14-19) shaped to fit stably into the recess 22D, and an integrally-formed latch 28D formed by a resilient finger 29D with protrusion 30D that extends longitudinally from the elongated section 25D. The resilient finger 29D is shaped to flex and assist in causing the protrusion 30D to releasably engage the side notch 23D to retain the head 24D in the recess 22D. The finger 29D extends at a slight angle to (but is generally parallel to) a length of the elongated section 25D. The finger 29D has a slightly increasing thickness to better distribute stress away from its base/root. The section 25D is generally rectangular and elongated and shaped to closely engage the mating recess 22, thus providing significant torsional stability. For example, our testing and product development showed that for some applications, such as for the illustrated box cutter tool cutting paper, the elongated section can be ½″ long by 7/16″ wide and about ⅛″ thick. It may include a slight taper longitudinally in order to facilitate molding and to facilitate a firm solid interconnection upon assembly with a handle recess. Notably, its cross-sectional size and shape and also length can be modified as required for particular tasks. The illustrated tool, when assembled, supports the head with torsional strength of more than about 20 in/lbs, or more preferably at least about 50 in/lbs, and further provides a tensile pull-out strength of more than about 20 lbs, or more preferably at least about 50 lbs.

In particular, the elongated section 25D extends longitudinally and closely engages the mating recess 22D within the handle 21D sufficient to provide a very stable interconnection that is tight (i.e., small enough clearances to allow connection but is not loose or sloppy) and that does not tend to become loose over time regardless of different direction of stresses and cycling of stresses on the respective head. Further, the structure must provide enough pull-out strength to prevent accidental pull-out of the head for particular functions. Notably, the protrusion 30D faces in a lateral direction perpendicular to a direction defined by the blades 27D, such that stresses on the blades 27D during use tend to be in a plane different than the direction of release for the latch 28D, such that using the blades does not result in forces that would cause the head 24D to unexpectedly release. The illustrated protrusion 30D engages the hole in the handle 21D with a snapping noise that confirms its positive engagement. The throat entering the blade area is defined by adjacent material in the body of the head and the handle, with the throat being angled slightly so that the sheet being cut approaches the blade edges at an angle for improved cutting characteristics. It is contemplated that the recess 22D and mating parts of the head 24D can be made so that the head 24D is reversible, so that the head 24D can be flipped 180 degrees and installed in either a first or inverted/flipped second position.

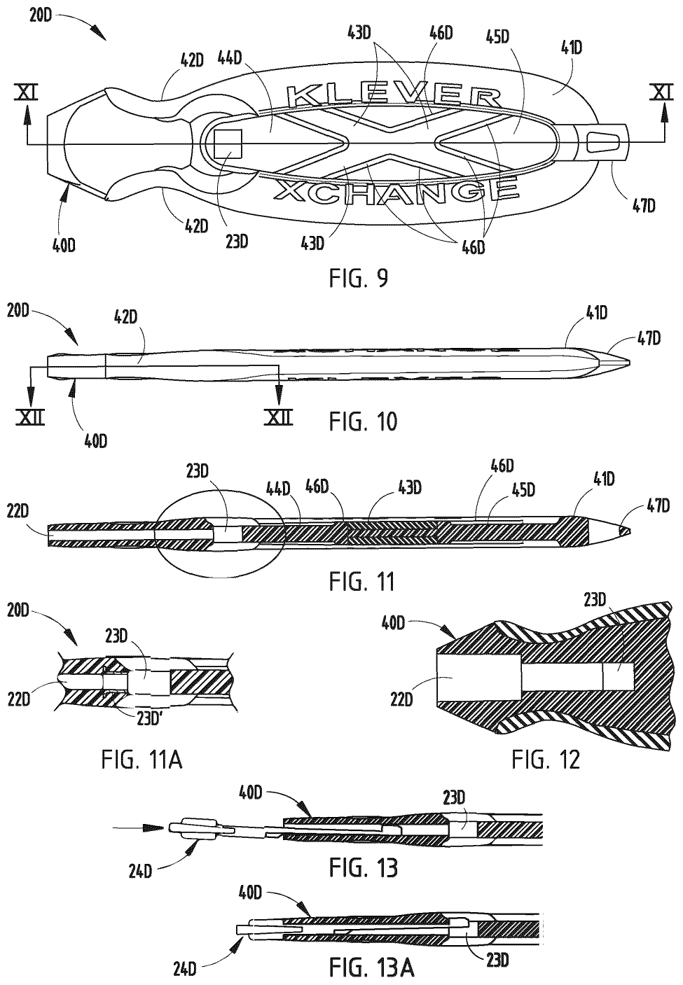

Notably, a thickness of the finger 29D is greater near the elongated section 25D, and may also include a radius at a base of the connection point, both of which better distribute stress away from the connection point of the elongated section 25D to the finger 29D. This helps avoid material fracture and failure at the connection point due to repeated cyclical flexing. Further, the recess 22D includes an inclined surface defining a ramp toward the side notch 23D which is configured to further assist protrusion 30D of the finger 29D to securely engage the mating side notch 23D. It is noted that a cross-sectional size of the illustrated finger 29D is less than that of the elongated section 25D, and both are rectangular, and also that the protrusion 30D is about a same width as the finger 29D. However, it is contemplated that other cross-sectional shapes and proportional size relationships are possible. It is also contemplated that an insert-molded metal sleeve 23D′ (see FIG. 11A) or C-shaped clip or other insert can be inserted molded into (or installed into) the hole/notch 23D for increased structural integrity and material strength of engagement with the protrusion 30D.

The illustrated head 24D (FIG. 20) includes a plastic body 31D that carries a single thin piece of steel with a continuous sharpened linear cutting edge that extends sufficiently to form both blades 27D, similar to head 24 described above. The body 31D includes material 32D on its operative end that holds the blades to the elongated section 25D and further includes two overhanging hook-shaped shields 33D that protect and cover outer edges of the single piece of steel. The end of the handle 21D combines with the shields 33D to define a shielded blade throat 34D, thus providing limited access to the exposed cutting edge of the blades 27D, and providing an improved degree of safety when using the blade to cut sheet material. The throat 34D also is shaped to define an angled entrance to the blades, such that the throat helps guide sheet material toward the blade at an angle during a cut.

Due to a strength and ergonomic shape of the present handle 21D, it can be used to matably engage and support various heads with different utilitarian functions (see FIG. 21), even where those functions result in significant torsional and/or lateral stress to the overall tool. Thus, the handle 21D can be used to form a variety of different tools. For example, a head 24E for engaging the handle 21D includes a thin-metal roller blade SOE shaped to cut a pizza or soft food product. The head 24E includes elongated section (like section 25D) for stably engaging the handle and a resilient finger (like finger 29D) for engaging the handle 24D, and further includes side supports 51E supporting an axle 52E of the roller blade SOE. A head 24F includes sections 25D and 29D and also includes opposing jaws 53F and 54F, jaw 54F being adjustable and useful for turning small nuts on threaded bolts. A head 24G includes sections 25D and 29D and also includes a hammer-like end 55G useful for hammering in small nails and the like, such as for hanging a picture on a wall-attached bracket. A head 24H includes sections 25D and 29D and also includes a spatula-shaped (metal or plastic) flat end 56H useful for slipping under food (such as a pancake) or for spreading paste. A head 241 includes sections 25D and 29D and also includes a flat square panel-like plastic end 571 useful for spreading caulking between and along tile, such as in bathroom wall or around a tub. Each corner of the plastic end 571 has a different shape or radius, so that differently shaped grooves or flats are formed as the selected corner is pulled along the gap between adjacent tiles on a given wall. The plastic end 571 can be made of resilient plastic or be made of material thin enough to flex or be made with material that seals as it slide across a tile surface, so that it both cleans the tile and also gives a proper feel during use. A head 24J includes a magnifying glass 58J, a head 24K includes a screw driver end 59K, and a head 24L includes a brush end 60L. All heads are configured to releasably snap into the handle 21D.

It is to be understood that variations and modifications can be made on the aforementioned structure without departing from the concepts of the present invention, and further it is to be understood that such concepts are intended to be covered by the following claims unless these claims by their language expressly state otherwise.

1.-20. (canceled)

21. A cutting tool, comprising:
a handle comprising,
a first face and a second face each extending between a first end of the handle a second end of the handle, wherein the first face is opposite the second face,
a recess extending into an interior of the handle,
a slot formed in the first end of the handle and defining a first opening to the recess, and
a notch formed in the first face of the handle and defining a second opening to the recess; and
a cutter head detachably received in the recess of the handle, the cutter head comprising,
a body at a first end of the cutter head, wherein the body is configured to retain a cutting blade, and
a latch at a second end of the cutter head, wherein the latch comprises a flexible finger and a protrusion formed at a distal end of the flexible finger.

22. The cutting tool of claim 21, further comprising an insert installed in one or more walls of the recess.

23. The cutting tool of claim 22, wherein the insert is positioned within the recess to border the notch.

24. The cutting tool of claim 22, wherein the insert is a metal sleeve or metal clip.

25. The cutting tool of claim 21, further comprising a grip area in each lateral edge of the handle, wherein the grip area is defined by the lateral edges of the handle curving inward toward a midline of the handle.

26. The cutting tool of claim 25, wherein the grip area is formed between the first end and the notch.

27. The cutting tool of claim 21, further comprising cross ribs on at least one of the first face or the second face of the handle.

28. The cutting tool of claim 27, wherein the cross ribs define one or more recessed areas on the first face or the second face of the handle.

29. The cutting tool of claim 21, wherein the notch intersects with and forms an end of the recess.

30. The cutting tool of claim 21, wherein the protrusion is configured to releasably engage with the notch when the cutter head is attached to the handle.

31. The cutting tool of claim 21, further comprising an inclined surface formed on a wall of the recess.

32. The cutting tool of claim 31, wherein the inclined surface is a ramp toward the notch of recess and the ramp is configured to flex the flexible finger to urge the protrusion to engage with the notch.

33. The cutting tool of claim 21, wherein the protrusion is formed on a first face of the flexible finger.

34. The cutting tool of claim 21, wherein the flexible finger extends at an angle relative to the body of the cutter head, such that the distal end of the flexible finger is offset relative to a proximal end of the flexible finger.

35. The cutting tool of claim 21, wherein the flexible finger decreases in thickness between a proximal end of the flexible finger and the distal end of the flexible finger.

36. A cutting tool, comprising:
a handle comprising,
a first face and a second face each extending between a first end of the handle a second end of the handle, wherein the first face is opposite the second face,
a recess extending into an interior of the handle,
an insert installed in one or more walls of the recess,
an inclined surface formed on one of the one or more walls of the recess,
a slot formed in the first end of the handle and defining a first opening to the recess, and
a notch formed in the first face of the handle and defining a second opening to the recess; and
a cutter head detachably received in the recess of the handle, the cutter head comprising,
a body at a first end of the cutter head, wherein the body is configured to retain a cutting blade, and
a latch at a second end of the cutter head, wherein the latch comprises a flexible finger and a protrusion formed at a distal end of the flexible finger.

37. The cutting tool of claim 36, wherein the insert is positioned within the recess to border the notch.

38. The cutting tool of claim 36, wherein the inclined surface is a ramp toward the notch of the recess and the ramp is configured to flex the flexible finger to urge the protrusion to engage with the notch.

39. The cutting tool of claim 36, wherein the flexible finger extends at an angle relative to the body of the cutter head, such the distal end of the flexible finger is offset relative to a proximal end of the flexible finger.

40. A cutting tool, comprising:
a handle comprising,
a first face and a second face each extending between a first end of the handle a second end of the handle, wherein the first face is opposite the second face,
a recess extending into an interior of the handle,
an insert installed in one or more walls of the recess,
an inclined surface formed on one of the one or more walls of the recess,
a slot formed in the first end of the handle and defining a first opening to the recess, and
a notch formed in the first face of the handle and defining a second opening to the recess; and
a cutter head detachably received in the recess of the handle, the cutter head comprising,
a body at a first end of the cutter head, wherein the body is configured to retain a cutting blade, and
a latch at a second end of the cutter head, wherein the latch comprises a flexible finger extending at an angle relative to the body and a protrusion formed at a distal end of the flexible finger.
